(19) United States
(12) Patent Application Publication
(10) Pub. No.: US 2010/0018730 A1
(43) Pub. Date: Jan. 28, 2010

(54) Optimized scuffle hoe, multi-purpose garden tool

(76) Inventor: Gloria Jean Schultz, Salt Lake City, UT (US)

Correspondence Address: Gloria Schultz, 4092 S. 670 E. Unit H, Salt Lake City, UT, 84107, US

(21) Appl. No.: 12/383,332

(22) Filed: Mar. 23, 2009

Related U.S. Application Data
(60) Provisional application No. 61/072,524, filed on Mar. 24, 2008.

(51) Int. Cl. A01B 1/10; A01B 1/06; A01B 1/22

(52) U.S. Cl. 172/371

(57) ABSTRACT

The tool is an optimized scuffle hoe that maximizes the efforts of the user in forward and backward motion, and that provides the functions of multiple garden tools, all-in-one. The tool comprises a V-shaped head portion having an open interior with blades that are sharpened on both inside and outside, the ends of which blades curve upward toward each other and attach to a handle portion. The primary use of the tool is for weeding, but with the addition of the nail notch the tool is used in construction and similar trades.

### CROSS-REFERENCE TO RELATED APPLICATIONS

This application claims the benefit of PPA application No. 61/072,524 filed Mar. 24, 2008.

### FEDERALLY SPONSORED RESEARCH

None.

### SEQUENCE LISTING

None.

### BACKGROUND

1. Field of Invention

This invention generally relates to gardening and landscaping. The improved blade design can be used as a weeder, an edger, a furrower, and more.

2. Prior Art

Previously, the garden hoe has been associated with a laborious and sometimes painful task of weeding. Even so, the hoe has long been a useful tool in the yard and gardening arena. The original, blunt hoe design is also limited in its ability to work soil.

The scuffle hoe was invented as a possible alternative to some of the problems created by the original hoe. Some improvements include relieving strain on the back from lifting and pulling the original hoe. However, the scuffle hoe was limited in its design. Some problems can be seen in the examples cited as follows:

U.S. Pat. No. 5,046,254 to Russell (1991) presents several problems including the use of too many parts. The drawbacks of too many parts include high cost of manufacture and higher probability of tool failure. The cutting blade is only on the front, limiting the action of the tool to forward motion. There are several notches in the blade, making sharpening an arduous task. The handle is shaped so that the force is directed above the blade rather than into the blade. This creates a top-heavy effect, and renders the tool ineffective. Its overall use is limited in function.

U.S. Pat. No. 2,011,062 to Masamitsu (1935), though simple in construction, has flaws in the blade design. The solid blade doesn't allow user to see where the tool is working. Limited visibility can result in roots of vital plants being cut. For safety, a user may need to hand-pick weeds growing near other plants.

U.S. Pat. No. 1,895,055 to Streinhour (1933) uses a serrated edge, which is difficult to sharpen. Serrated edges tend to get caught in organic matter such as roots and stalks. The blade in this example also is sharpened only on one side. The only cutting action would be in a forward motion. Overall use is limited.

U.S. Pat. No. 1,777,029 to Bradford (1930) uses too many parts. It has some blade surface for cutting in pulling motion, but the scope is limited. Having the reverse blades only on the sides makes working the soil awkward. Such construction misses the focal area being worked by the forward blades. Again, the flat blade provides limited visibility as it works beneath the soil.

### SUMMARY

In accordance with the embodiment the invention, an improved scuffle hoe, comprises a combination of attributes from various gardening tools, maximizing its usefulness. It is comprised at the head or blade portion of a V-shaped or curved strip of metal, the ends of which curve toward each other to attach to a handle portion. This creates an open design which allows for debris and other material to pass through. The open or hollow interior also allows the tool to be placed over and around plants.

The lightweight, open, and ergonomic design makes the tool easier to use than other tools. Lifting and thrusting is basically eliminated because of the push/pull ability, making the use of the tool easier on the body. The open design eliminates the self defeating drag and resistance of solid tools which stress the body.

### DRAWINGS—FIGURES

FIG. 1 is an aerial view of the head portion, constructed in accordance with the invention and showing the attachment to the lower end of the handle portion.

FIG. 2 is a perspective left-side view of the scuffle hoe of FIG. 1.

FIG. 3 is a perspective plane-of-handle view of the scuffle hoe of FIG. 1.

FIG. 4 is an aerial side-angle view of the scuffle hoe of FIG. 1.

### DRAWINGS—REFERENCE NUMERALS

11 head portion
12 V-shaped blade
13 outer or forward facing blades
14 inner or backward facing blades
15 side curvature
16 foothold
17 fastener or attachment to handle
18 ground level
19 plane of handle

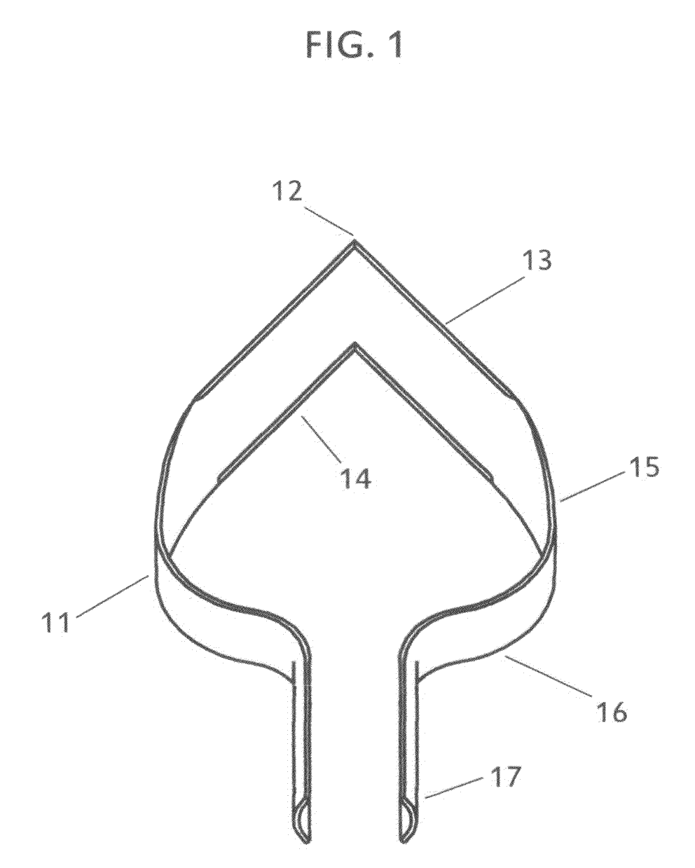

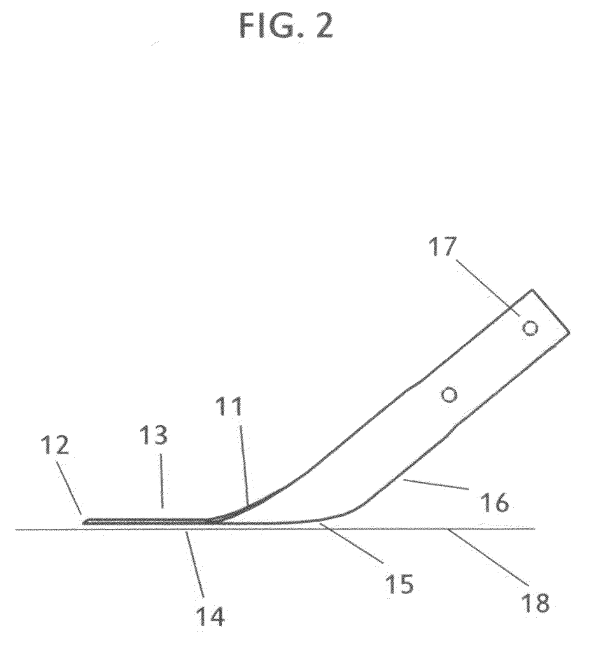

### DETAILED DESCRIPTION—FIGS. 1, 2,3,4—PREFERRED EMBODIMENT

FIG. 1 comprises an aerial view of the head portion 11 constructed in accordance with the invention. The forward portion 12 is in a V-shape or curved with outer blades 13, and inner blades 14. These may be sharpened, or merely thinned to facilitate a cutting or leveling action when this embodiment is pushed or pulled along the ground. The strip of metal comprising the head portion 11 curves in such a way 15 to ensure materials passing through the open portion of the embodiment are distributed evenly. Above the curve, a flat section 16 may be included where the user's foot may be placed for added force, if needed. The head portion 11 is fastened to the handle portion 18, which may be employed with bolts 17 or other methods befitting high standards of construction.

FIG. 2 comprises a perspective left-side view of the head portion 11 and handle portion 18. This view shows the probable angle from the ground level 19 during normal standing use.

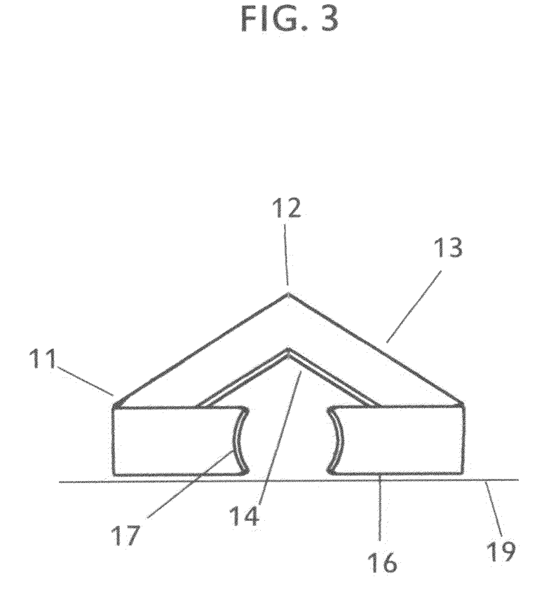

FIG. 3 comprises a perspective plane-of-handle view further demonstrating the viewpoint of FIG. 2.

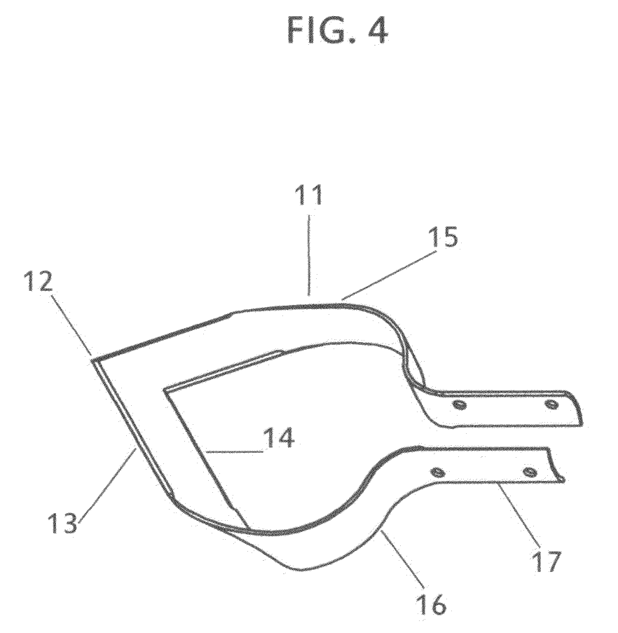

FIG. 4 comprises an aerial side-angle view further demonstrating the viewpoint of FIG. 1.

An object is to have a central piercing point and two cutting edges diverging from the point. The blades diverging from the point are used to cut in a thrusting and pulling motion. The angle of the blades from the piercing point outward may be angled +/−90 degrees.

By sharpening or thinning both the outer and the inner portions of the V-shaped or curved blade a cutting action is created when the user pushes forward and pulls back during use. This forward and backward ability optimizes the user's efforts, lessening the amount of time and work required to complete tasks. The shape also facilitates other functions including but not limited to edging, leveling of dirt and gravel, spading, cultivating, furrowing, and de-icing.

The usefulness of the invention is possible in various sizes including a hand-held size. A post or ledge may also be added on the head portion of the long handled invention to allow the user to use foot pressure for further effectiveness. The lightweight, open, and ergonomic design makes the tool easier to use than other tools. Lifting and thrusting is basically eliminated because of the push/pull ability, making the use of the tool easier on the body. The open design eliminates the self defeating drag and resistance of solid tools which stress the body. The open or hollow interior also allows the tool to be placed over and around plants.

Because of the design, the tool is lighter in weight than most similar tools. This open design uses less raw material and labor to manufacture, especially when made with the 90 degree angle which produces the maximum number of blades per raw material product. Because of both the open design and light weight, the tool can be shipped more economically, more tools per container. One major advantage of this is the fuel savings.

The tool may be formed made with a variety of materials, but performs best when made of tempered steel or other material that is hardy and suitable for working through rock, gravel, compacted dirt, ice, or other elements. New plastics are being developed that will also be strong enough for use in both the head and handle portions.

The ease with which this invention is used brings a new era of garden and landscape enjoyment to the user. The tool will take the gardening and landscaping tasks from what were once backbreaking and labor intensive drudgery to an experience which is enjoyable and rewarding. The parallel operation of the tool, along with the lightweight, open, and ergonomic design will help to maintain the safety and health of the operator because of the ease of use.

The time saved due to the innovative design and operation, V-shaped or curved, sharpened double-sided blade, open interior and curved arms is significant and is a value added to quality of life.

The tool may be made as a one piece blade or made with multiple parts welded together. The one piece blade is most efficient to manufacture and use, with no moving parts to break or wear out.

The handle portion may be constructed from any suitable handle material and shape including but limited to metal, fiberglass, wood, plastic, or rubber. The handle portion may also be smooth or textured, of varied widths or diameters, and of varied lengths including one piece or expandable sections.

The head or blade portion may be attached to the handle portion with any method well known in the art of attaching to a tool including but not limited to nuts and bolts, rivets, screws, pins, glue or other adhesive. The head portion may also be made to include as a part of the head a tubular section into which the handle may be inserted.

### OPERATION—FIGS. 1, 2,3, 4—PREFERRED EMBODIMENT

Normal operation includes several functions. The primary use is as a scuffle hoe. With the head portion 11 level with the ground 19 the invention is pushed forward with a cutting action and pulled back providing more cutting action. This is useful in clearing weeds—even very thick ones—as well as leveling mounds of dirt or gravel. The side curvature 15 serves to gather or “scoop” materials and distribute them evenly on the ground or give a quick toss to the debris pile. For thicker weeds or harder dirt, the user's foot may be placed on the top portion 16 of the head for added force. This top portion may include a foot press on some models.

The tool may be inverted to provide added uses. Inverted, this embodiment can clear small concise areas with the V-tip 12—useful in clearing areas around plants, and avoiding roots—as well as wider strips by using the blade 13 flush with ground level 19. The V-tip can further be inverted and used for furrowing and edging.

The entire combination of the blade shape comes in handy for leveling large mounds of dirt or other material. By placing the handle 18 perpendicular to the ground 19, both upright and inverted, the head portion 11 scoops and pushes dirt and other materials. This is convenient as the user can level a mound of dirt and continue other functions, all with one tool.

The tool may be inverted to provide added uses including furrowing for irrigation and planting seeds. The multipurpose tool can also be used for ice removal. The open or hollow interior also allows the tool to be placed over and around plants.

### ADVANTAGES—FIGS. 1, 2, 3, 4—PREFERRED EMBODIMENT

A number of advantages of some embodiments of the Optimized Scuffle Hoe are clear. The tool is obviously useful in clearing weeds and unwanted plants. An advantage is that the tool can leave the bark or soil undisturbed while removing the unwanted plants.

The ease with which this invention is used brings a new era of garden and landscape enjoyment to the user. The tool will take the gardening and landscaping tasks from what were once backbreaking and labor intensive drudgery to an experience which is enjoyable and rewarding—in a fraction of the time.

The tool may be inverted to provide added uses including furrowing for irrigation and planting seeds. This may very well be the first garden hoe to be used in the construction and building trades.

The ability to have a variety of sizes from a hand held to long handled device adds to the usefulness. The tool may be used by persons of almost any age.

### CONCLUSIONS, RAMIFICATIONS, AND SCOPE

Thus, the reader will see that at least one embodiment of the Optimized Scuffle Hoe provides a more reliable, lightweight, ergonomically friendly, and economical device that can be used for multiple purposes by persons of almost any age.

### SUMMARY

The tool comprises a V-shaped head portion having an open interior with blades that are sharpened on both inside and outside edges, the ends of which blades curve upward toward each other and attach to a handle portion The lightweight, open, and ergonomic design makes the tool easier to use than other tools.
By sharpening or thinning both the outer and the inner portions of the V-shaped blade, a cutting action is created when the user pushes forward and pulls back during use. This ability optimizes the user's efforts, lessening the amount of time and work required to complete tasks.
The lifting and thrusting required by other tools can do damage to the body in the form of muscle, neck, and back strain. This is significantly reduced because of the push/pull ability of the new design, making the use of the tool easier on the body.
The tool can also be used as an edger, furrower, de-icer, with multiple use in the construction trade.

I claim:

1. An improved gardening and landscaping tool consisting essentially of a head with the blade portion comprising a beveled, double sided V-shaped blade that is sharpened on both the inside and outside edges and having an open V-shaped interior with the curved arms extending upward to attach to the handle portion.

2. An improved gardening and landscaping tool comprising a tool portion including first and second legs consisting of essentially a 90 degree angle from the apex or V-point, but not limited to this angle in the V-shape configuration. Said angle of said tool may be comprised more or less than the 90 degree angle as presented in the drawings and specifications and long as the V-shape and open interior are honored.

3. An improved gardening and landscaping tool comprising a tool portion consisting of a V-shaped member having first and second legs meeting at a vertex with each leg including a top surface, a bottom surface, and an axis of elongation.

4. An improved gardening and landscaping tool comprising a tool portion consisting of a V-shaped member that includes blades being formed into a double-sided V-shape including sharpened, straight, beveled, knife-like edges with an open interior.

5. An improved gardening and landscaping tool comprising a tool portion consisting of a V-shaped member and including an open interior between the two extended V-shaped arms, said open interior including sharpened, straight, beveled, knife-like edges.

6. An improved gardening and landscaping tool comprising a tool portion consisting of a one piece blade or a blade welded at the V-point or apex.

7. An improved gardening and landscaping tool comprising a tool portion consisting of a handle which may be of various lengths, various circumferences, and various diameters and may be of a variety of materials.

8. An improved gardening and landscaping tool comprised to weed, edge, cultivate, and groom said working surface during a pushing motion of said tool.

9. An improved gardening and landscaping tool comprised to weed, edge, cultivate, and groom said working surface during a pulling motion of said tool.

10. An improved gardening and landscaping tool comprising a tool portion consisting of two continuous arms which curve up from the V-shaped flat portion of said tool and are attached to the elongated handle portion, the curvature design of the arms to the handle being ergonomically friendly and able to maximize effort to effect in the energy output.

11. An improved gardening and landscaping tool comprising a tool portion consisting of a blade comprised of and mounted to said distal end of said elongated handle, traverse with respect to said first axis. A means for mounting said blade to said handle is comprised of, but is not limited to, bolts and rivets.

12. An improved gardening and landscaping tool comprising a tool portion consisting of a handle portion comprised of lengths that are known to garden tools, including but not limited to hand tools with a length of approximately 12 inches and standing tools with handles of a length approximately 48 to 60 inches.

13. A head portion.

14. A handle portion
